(19) United States
(12) Patent Application Publication
(10) Pub. No.: US 2016/0044369 A1
(43) Pub. Date: Feb. 11, 2016

(54) ELECTRONIC DEVICE AND METHOD RECORDED-PROGRAM PROCESSING METHOD

(71) Applicants: Kabushiki Kaisha Toshiba, Tokyo (JP); Toshiba Lifestyle Products & Services Corporation, Tokyo (JP)

(72) Inventor: Takashi Ohshima, Fussa (JP)

(21) Appl. No.: 14/553,646

(22) Filed: Nov. 25, 2014

(30) Foreign Application Priority Data
Aug. 5, 2014 (JP) 2014-159663

(51) Int. Cl. H04N 21/4335; H04N 21/4147; H04N 21/433

(52) U.S. Cl. CPC H04N 21/4335; H04N 21/4334; H04N 21/4147

(57) ABSTRACT

According to one embodiment, an electronic device includes a program erasure which erases a recorded program included in a plurality of recorded programs and recorded earlier than other recorded programs, and a program recorder which records, in an area from which the recorded program is erased by the program erasure, new programs broadcasted in a predetermined time zone and a time zone other than the predetermined time zone. The program erasure erases a program recorded in the predetermined time zone, later than a program recorded earliest in the time zone other than the predetermined time zone, and earlier than a program which was broadcasted in the time zone other than the predetermined time zone and was recorded after the program recorded earliest.

### CROSS-REFERENCE TO RELATED APPLICATIONS

This application is based upon and claims the benefit of priority from Japanese Patent Application No. 2014-159663, filed Aug. 5, 2014, the entire contents of which are incorporated herein by reference.

### FIELD

Embodiments described herein relate generally to an electronic device for processing recorded programs, and a recorded-program processing method.

### BACKGROUND

Nowadays, broadcast receiving apparatuses which simultaneously record a plurality of programs broadcasted in the same time zone are available. In these apparatuses, when only a small residual memory capacity for recording programs is left, a necessary memory capacity is secured by sequentially erasing already recorded programs, beginning with the oldest one.

There is a known technique, used to erase programs, of determining the degree of priority of each program to be erased, based on the number of replays of each recorded program, or on the time and date of replay of the same, and sequentially erasing the programs in increasing order of priority degree.

However, if the order of priority of programs to be erased is determined based on the number of replays of each recorded program, or on the time and date of replay of the same, the priority degree of a program that is not yet replayed becomes low, and such programs may be erased and be unable to be viewed.

In view of the above circumstances, it is an object of the embodiment to provide an electronic device, in which the order of erasure is set such that erasure of a program that is not yet replayed but may well be replayed by a user is postponed, compared to a program having a weak possibility of replay.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing a configuration example of an electronic device according to a first embodiment;

FIG. 2 shows an example of a recorded-program list obtained when time-shift recording has been performed;

FIG. 3 is a histogram showing the numbers of replays of recorded programs in respective time zones;

FIG. 4 shows a list of first programs recorded in certain time zones, in which list programs having been actually replayed are hatched;

FIG. 5 shows a list of second programs recorded in certain time zones;

FIG. 6 shows a list of first programs recorded in other time zones;

FIG. 7 shows a list of second programs recorded in other time zones;

FIG. 8 is a flowchart for explaining how the electronic device of the first embodiment erases recorded programs; and

FIG. 9 is a block diagram showing a configuration example of an electronic device according to a second embodiment.

### DETAILED DESCRIPTION

Broadcast program receiving apparatuses according to first and second embodiments will be described hereinafter with reference to the accompanying drawings.

In general, according to one embodiment, an electronic device includes a program erasure configured to erase a recorded program included in a plurality of recorded programs and recorded earlier than other recorded programs; and a program recorder configured to record, in an area from which the recorded program is erased by the program erasure, new programs broadcasted in a predetermined time zone and a time zone other than the predetermined time zone. The program erasure erases a program recorded in the predetermined time zone, later than a program recorded earliest in the time zone other than the predetermined time zone, and earlier than a program which was broadcasted in the time zone other than the predetermined time zone and was recorded after the program recorded earliest.

### First Embodiment

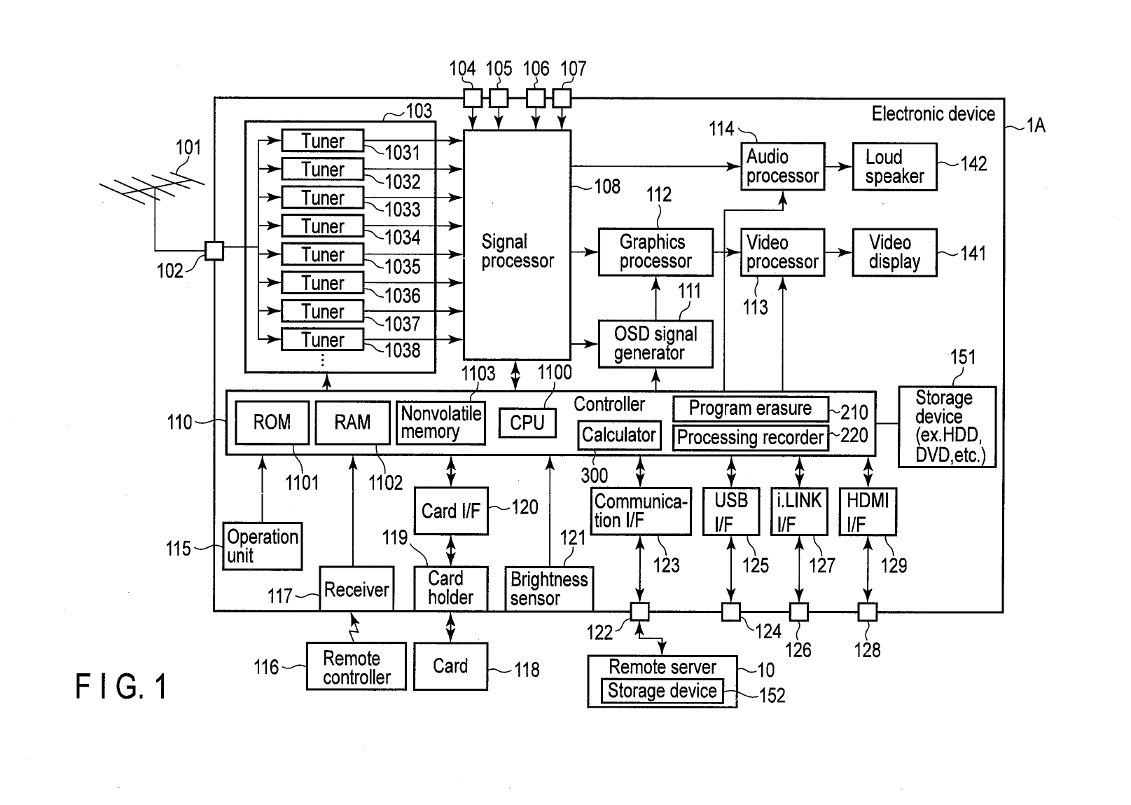

FIG. 1 shows the configuration of an electronic device 1A according to the first embodiment.

As shown in FIG. 1, the electronic device 1A of the first embodiment comprises an antenna 101, an input terminal 102, a tuner unit 103, external input terminals 104 to 107, a signal processor 108, a controller 110, an OSD signal generator 111, a graphics processor 112, a video processor 113, an audio processor 114, an operation unit 115, a receiver 117, a card holder 119, a card interface 120, a brightness sensor 121, a LAN terminal 122, a communication interface 123, a USB terminal 124, a USB interface 125, an iLINK terminal 126, an iLINK interface 127, an HDMI (trademark) terminal 128, an HDMI interface 129, a video display 141, a loud speaker 142, a storage device 151, a program eraser 210, a program recorder 220 and a calculator 300. The program eraser 210, the program recorder 220 and the calculator 300 may be formed integral with the controller 110 as shown in FIG. 1, or be formed independently of the controller.

Further, the tuner unit 103 comprises tuners 1031 to 1038 for terrestrial digital TV broadcasts, and tuners for BS/CS digital TV broadcasts. Using the tuners 1031 to 1038 for terrestrial digital TV broadcasts, a program table corresponding to the terrestrial digital TV broadcasts can be received and displayed. Similarly, using the tuners for BS/CS digital TV broadcasts, program tables corresponding to the BS/CS digital TV broadcasts can be received and displayed.

In the first embodiment, a description will be given of a case where the electronic device 1A comprises the video display 141 and the loud speaker 142, as shown in FIG. 1. However, the electronic device 1A is not limited to this. For instance, the electronic device 1A does not have to comprise the video display 141 or the loud speaker 142. Namely, the electronic device 1A may be connected to the video display 141 and the loud speaker 142 via connection means, such as HDMI.

Also, in the first embodiment, the electronic device 1A comprises the storage device 151 as shown in FIG. 1. However, the electronic device 1A is not limited to this. For instance, the electronic device 1A does not have to comprise the storage device 151. Namely, the electronic device 1A may be connected to an external storage device (such as an HDD) via connection means, such as the USB terminal 124 and the USB interface 125.

Furthermore, in the first embodiment, the electronic device 1A comprises a plurality of tuners as shown in FIG. 1. However, the electronic device 1A is not limited to this. For instance, the electronic device 1A does not have to comprise the tuners. In this case, the electronic device 1A may receive Internet protocol (IP) broadcasts via the LAN terminal 122, and replay or record programs corresponding to plural channels of the IP broadcasts.

The electronic device 1A will be described in detail.

Terrestrial digital TV broadcast signals received by the antenna 101 for terrestrial digital TV broadcasts are supplied to the tuners 1031 to 1038 via the input terminal 102, and are selected by respective terrestrial digital TV broadcast processors associated with the tuners. The digital TV broadcast signals selected by the tuners 1031 to 1038 are supplied to the signal processor 108, where they are demodulated into digital video and audio signals.

The signal processor 108 executes respective predetermined digital signal processings on the digital video and audio signals, and outputs the resultant signals to the graphics processor 112 and the audio processor 114.

Further, the signal processor 108 is connected to, for example, four input terminals 104 to 107. The input terminals 104 to 107 enable analog video and audio signals to be supplied from the outside of the electronic device 1A.

The signal processor 108 digitizes analog video and audio signals supplied via the input terminals 104 to 107, and executes respective predetermined digital signal processings on them, thereby outputting resultant signals to the graphics processor 112 and the audio processor 114.

The graphics processor 112 has a function of superimposing, upon each digital video signal supplied from the signal processor 108, an OSD signal generated by an on-screen-display signal generation module 111. The graphics processor 112 can selectively output the output video signal of the signal processor 108 and the output OSD signal of the OSD signal generator 111, and can output a combination of both the outputs so that the outputs constitute respective halves of a screen.

The digital video signal output from the graphics processor 112 is supplied to the video processor 113. The video signal processed by the video processor 113 is supplied to the video display 141. The video display 141 displays a video image based on the video signal.

The audio processor 114 converts the input digital audio signal into an analog audio signal of a format with which the signal can be reproduced by the loud speaker 142, and then outputs the resultant analog audio signal to the loud speaker 142 to cause the same to reproduce the analog audio signal.

The electronic device 1A performs all operations, including the above-mentioned various reception operations, under the control of the controller 110. The controller 110 comprises, for example, a central processing unit (CPU) 1100. Upon receiving operation information (various instructions) from the operation unit 115, or receiving operation information (various instructions) from a remote controller 116 via the receiver 117, the controller 110 controls various modules to reflect the operation information. The receiver 117 and the remote controller 116 may utilize wireless communication based on electric waves or utilize infrared rays to transmit and receive operation signals.

The controller 110 also comprises a read only memory (ROM) 1101 that stores control programs executed by the CPU 1100, a random access memory (RAM) 1102 serving as a work area for the CPU 1100, and a nonvolatile memory 1103 that stores various types of setting and control information, etc.

The controller 110 is connected via a card interface 120 to a card holder 119 for holding a memory card 118. By means of the memory card 118 held by the card holder 119 and the card interface 120, the controller 110 can perform information transmission.

The controller 110 is also connected to the LAN terminal 122 via the communication interface 123. Accordingly, the controller 110 can transmit and receive information via the communication interface 123 to and from a LAN-compatible device connected to the LAN terminal 122. In this case, the controller 110 has a Dynamic Host Configuration Protocol (DHCP) server function, and assigns, for control, an Internet Protocol (IP) address to the LAN-compatible device connected to the LAN terminal 122. Further, the controller 110 can communicate a data server 10 via the communication interface 123. The data server 10 comprises a storage device 152 (e.g., an HDD).

The controller 110 is further connected to the HDMI terminal 128 via the HDMI interface 129. Accordingly, the controller 110 can transmit and receive information via the HDMI interface 129 to and from an HDMI-compatible device connected to the HDMI terminal 128.

The controller 110 is yet further connected to the USB terminal 124 via the USB interface 125. Accordingly, the controller 110 can transmit and receive information via the USB interface 125 to and from a USE-compatible device connected to the USB terminal 124.

The controller 110 is further connected to the iLINK terminal 126 via the iLINK interface 127. Accordingly, the controller 110 can transmit and receive information via the iLINK interface 127 to and from an iLINK-compatible device connected to the iLINK terminal 126.

Further, the controller 110 receives a brightness detection signal from the brightness sensor 121. Based on the brightness detection signal, the controller 110 can control the brightness of video images and a backlight.

The controller 110 can also control an operation of recording a descrambled broadcast signal, selected by the tuner unit 103, in the storage device 151 or in an external storage device (such as an HDD) connected via the LAN terminal 122 or the USB terminal 124. As described above, since the tuner unit 103 comprises the plurality of tuners 1031 to 1038, the electronic device 1A can simultaneously record or display programs of plural channels. Further, the electronic device 1A has a function of authenticating a scramble broadcast.

The electronic device 1A can record, for example, all programs of all channels (or designated channels) corresponding to one month (or corresponding to designated time zones of one month) with an image quality of high-definition level. This way of recording is called time-shift recording. When time-shift recording is performed, a user can replay and view, afterwards, all programs broadcasted within, for example, the past one month.

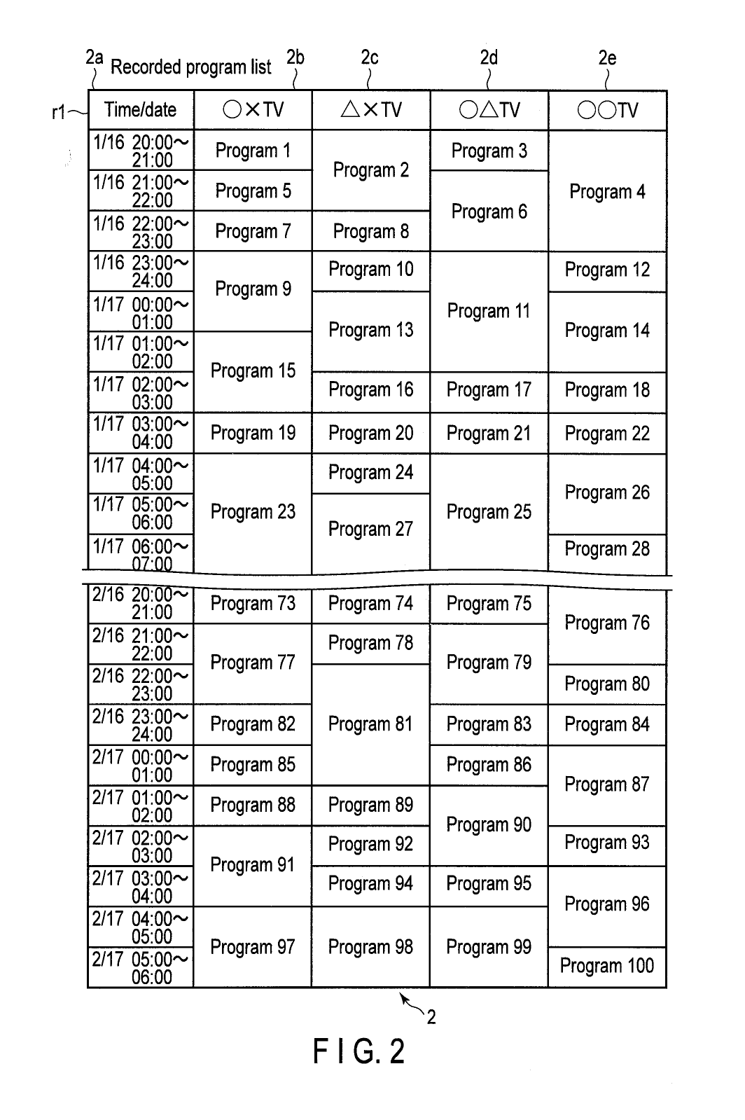

FIG. 2 shows a recorded-program list 2 recorded in the storage device 151 of the electronic device 1A that is currently performing time-shift recording. In the recorded-program list 2, programs 1 to 100 broadcasted by four broadcast stations from 20:00 of January 16 to 6:00 of February 17 are listed as replay-enabled programs. More specifically, in the recorded-program list 2, broadcast time zones and broadcast stations are displayed in columns, and a first row r1 displays the names of the broadcast stations. A first column 2a of the recorded-program list 2 displays the date and broadcast time zone of each recorded program, and a second column 2b displays programs broadcasted by a ◯× TV station. Similarly, a third column 2c displays programs broadcasted by a Δ× TV station, and a fourth column 2d displays programs broadcasted by a ◯Δ TV station. The fifth column 2e displays programs broadcasted by a ◯◯ TV station. For instance, program 7 displayed in the second column 2b was broadcasted by the ◯× TV station from 22:00 to 23:00 of January 16.

When the above-mentioned time-shift recording is continuously performed (when the program recorder 220, described later, continuously performs recording), if, for example, the free area of the recorder 151 becomes less than a predetermined amount (e.g., less than 10% of the entire capacity), the electronic device 1A erases a recorded program. The controller 110 comprises the program eraser 210 for erasing recorded-program data recorded in the storage device 151. The controller 110 further comprises the program recorder 220 for recording a new program in an area thereof from which a program has been erased. The program recorder 220 records new programs broadcasted both in predetermined time zones and in time zones other than the predetermined time zones. Further, the controller 110 comprises the calculator 300 for calculating a broadcast time zone (broadcast time zones) used as determination references associated with whether a program should be erased.

The above descriptions are associated with the structure employed in the electronic device 1A of the first embodiment. A description will now be given of an operation of the electronic device 1A of the first embodiment for processing programs recorded in the storage device 151.

In the first embodiment, the electronic device 1A is performing time-shift recording, and the program recorder 220 is continuously recording programs of plural channels in the storage device 151.

Since the electronic device 1A is continuously performing time-shift recording, it is necessary, as mentioned above, to erase programs recorded in the storage device 151 when the residual recording capacity of the storage device 151 becomes less than a predetermined value. When recorded programs are erased, if programs whose recorded times/dates are old are erased without any consideration, even recorded programs, whose possibility of being viewed by the user is strong, may well be erased, non-viewed. In light of this, the program eraser 210 determines whether a certain recorded program should be erased, by comparing the time zone(s) calculated by the calculator 300 with the broadcast time zone of the certain program.

Before describing the operations of the program eraser 210 and the program recorder 220, a description will be given of how the calculator 300 calculates a time zone (time zones) as a determination reference as to whether a program should be erased.

The calculator 300 divides one day, into a plurality of time zones, counts the number of replays of each program broadcasted and recorded in each time zone, and calculates a time zone (time zones) in which the number of replays of a program is greater than a predetermined threshold. Namely, the time zone(s) calculated by the calculator 300 is where the ratio of replays of a program is higher among the time zones where the program recorder 220 made recording. For instance, assuming that program 5 included in the recorded-program list 2 of FIG. 2 has been replayed, the calculator 300 counts one actual replay in a time zone of 21:00 to 22:00. Further, assuming that program 13 included in the recorded-program list 2 of FIG. 2 has been replayed, the calculator 300 counts one actual replay in each of time zones of 00:00 to 01:00 and 01:00 to 02:00.

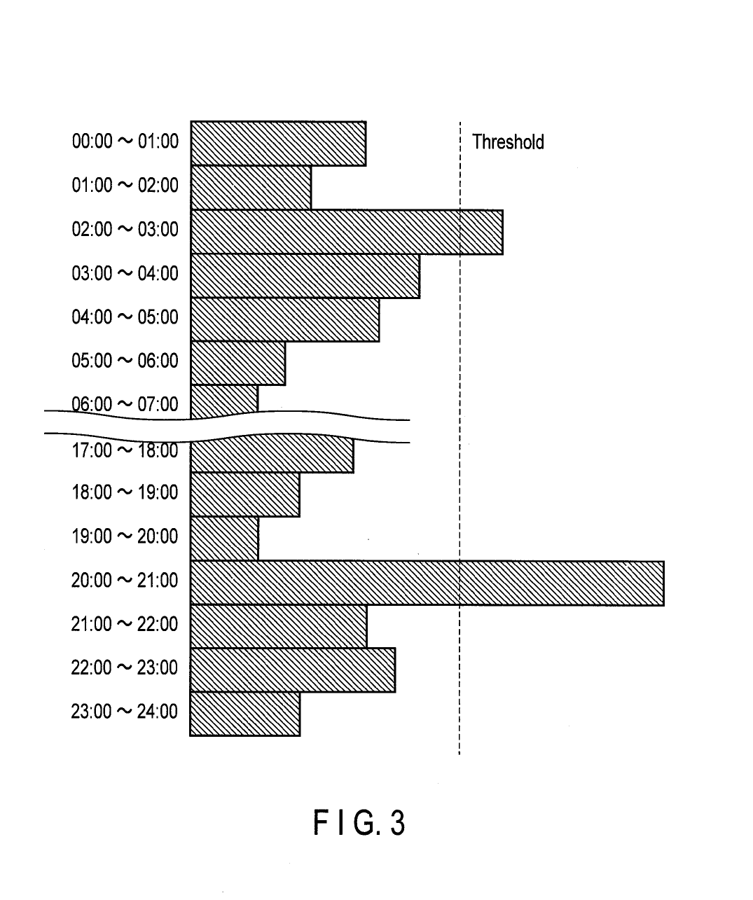

FIG. 3 is a histogram showing 24 time zones each corresponding to one hour, into which time zones one day is divided. In the respective time zones, programs have been replayed by the numbers of times indicated by the respective bars of the histogram. In the histogram of FIG. 3, the numbers of replays of recorded programs exceed a predetermined threshold in time zones of 02:00 to 03:00 and 20:00 to 21:00. In the histogram example of FIG. 3, the two time zones of 02:00 to 03:00 and 20:00 to 21:00 are obtained as the calculation result of the calculator 300.

Although in the above description, one day is divided in units of one hour, the time zone width can be adjusted appropriately. For instance, the time zone width may be 15 minutes, 30 minutes, or another time period. Further, in the above description, two time zones where the predetermined threshold is exceeded have been obtained as the calculation result. However, the calculator 300 may not set a threshold beforehand, and may select only one time zone where the number of replays is largest. Alternatively, the calculator 300 may select, for the calculation of a target time zone, a plurality of time zones where the numbers of replays are relatively large. Yet alternatively, the calculator 300 may calculate, as a time zone to be referred to, to determine whether recorded-program erasure should be performed, a time zone that is included in the time zones where the program recorder 220 made recording, and where a program whose frequency of replay is high is recorded. In other words, the calculator 300 does not count the number of replays of a program in each time zone, but counts the number of replays of each recorded program. After that, the calculator 300 calculates a time zone (time zones) where a recorded program, the number of replays of which exceeds the predetermined threshold, was broadcasted, as the time zone(s) to be referred to, to determine whether recorded-program erasure should be performed.

As described above, the calculator 300 performs calculation of a time zone(s) to be referred to, to determine whether recorded-program erasure should be performed. A description will then be given of operations of the program eraser 210 and the program recorder 220 performed to process programs recorded in the storage device 151.

As described above, the program eraser 210 determines whether to erase each recorded program, by comparing the time zone(s) calculated by the calculator 300 with the broadcast time zones of the recorded programs.

From the above, it is understood that each of the programs recorded in the storage 151 belongs to either a first group of recorded programs that are not yet subjected to a determination as to whether they should be erased, or a second group of recorded programs that are already subjected to the determination (i.e., the recorded programs that were not erased). The first and second groups of recorded programs may be recorded in one partition in an HDD, or in respective two partitions in the HDD.

The first and second groups of recorded programs will be described, assuming that the data capacities of the groups have respective upper limits. Namely, a description will be given of a case where the total recorded-program data belonging to the first group of recorded programs and the total recorded-program data belonging to the second group of recorded programs cannot exceed the upper limits.

If time-shift recording is continued to cause the total recorded-program data belonging to the first group to exceed the upper limit, the program eraser 210 determines whether programs included in the first group should be sequentially erased, beginning with the recorded program of the oldest time and date (hereinafter, referred to as an erasure candidate program). In other words, the program erasure 210 determines whether to erase programs included in the first group, beginning with the program recorded earliest. More specifically, if the erasure candidate program was not broadcasted in the time zone(s) calculated by the calculator 300, it is erased from the storage device 151 by the program erasure 210, and the program recorder 220 records a new program in the area of the storage device 151 from which the erasure candidate has been erased. In contrast, if the erasure candidate program was broadcasted in the time zone(s) calculated by the calculator 300, it is not erased. Namely, erasure of the erasure candidate is postponed (or delayed).

It is determined that the erasure candidate program determined not to be erased does not belong to the first group of recorded programs, but belongs to the second group of recorded programs. Since erasure candidate programs are extracted from the first group, an erasure candidate program shifted to belong to the second group is delayed in being erased by the program erasure 210. If the erasure candidate program is not erased from the storage device 151, the residual data capacity for the first group increases by the data amount of the erasure candidate program, while the residual data free area for the second group decreases by the same data amount. If the erasure candidate program is erased from the recorder 151, the residual data capacity for the first group increases by the data amount of the erasure candidate program, while the residual data free area for the second group does not change. Accordingly, if the erasure candidate program is erased from the storage device 151, the residual data free area of the storage device 151 increases. Since the residual data free area increases, the program recorder 220 can record a new program in the area from which data is erased by the program erasure 210.

If the total amount of the recorded program data included in the second group of recorded programs exceeds the above-mentioned upper limit (i.e., if it is determined that an erasure candidate program is not erased from the first group, and if the total amount of the recorded program data of the second group reaches the above-mentioned upper limit), the recorded programs in the second group are sequentially erased, beginning with the recorded program of the oldest time and date (or beginning with the program recorded earliest). In this case, the residual data free area of the second group of recorded programs decreases by the data amount of the erasure candidate program, and increases by the data amount of the erased recorded program. Since the residual data free area is thus increased, the program recorder 220 can record a new program in an area from which a previous program has been erased by the program erasure 210. If the recorded programs to be erased are changed such that they are not included in the first group of recorded programs but are included in the second group of recorded programs, the number of the to-be-erased recorded programs is adjusted to a value that does not exceed a predetermined amount of recorded program data.

As described above, the program erasure 210 erases a program recorded in a predetermined time zone, later than a program broadcasted in a time zone other than the predetermined time zone.

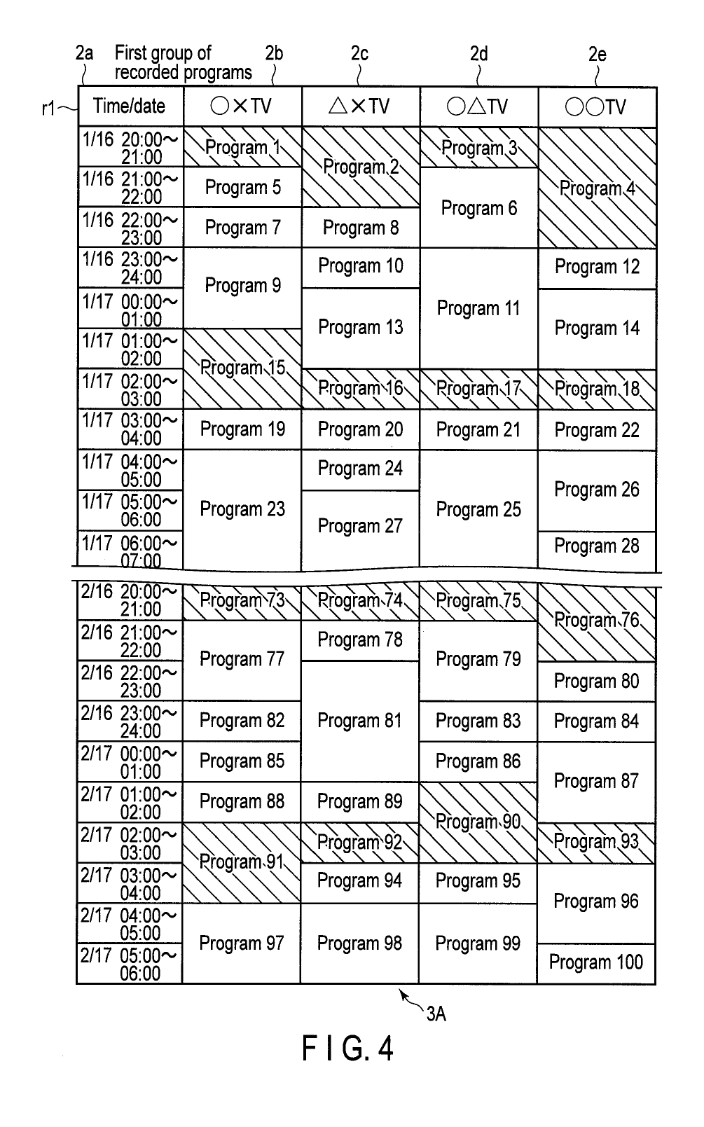

Assuming here that both the first and second groups of recorded programs have no data free area, and the time zones calculated by the calculator are 2:00 to 3:00 and 20:00 to 21:00, the above-described processing will now be described in more detail with reference to FIGS. 4, 5 and 6.

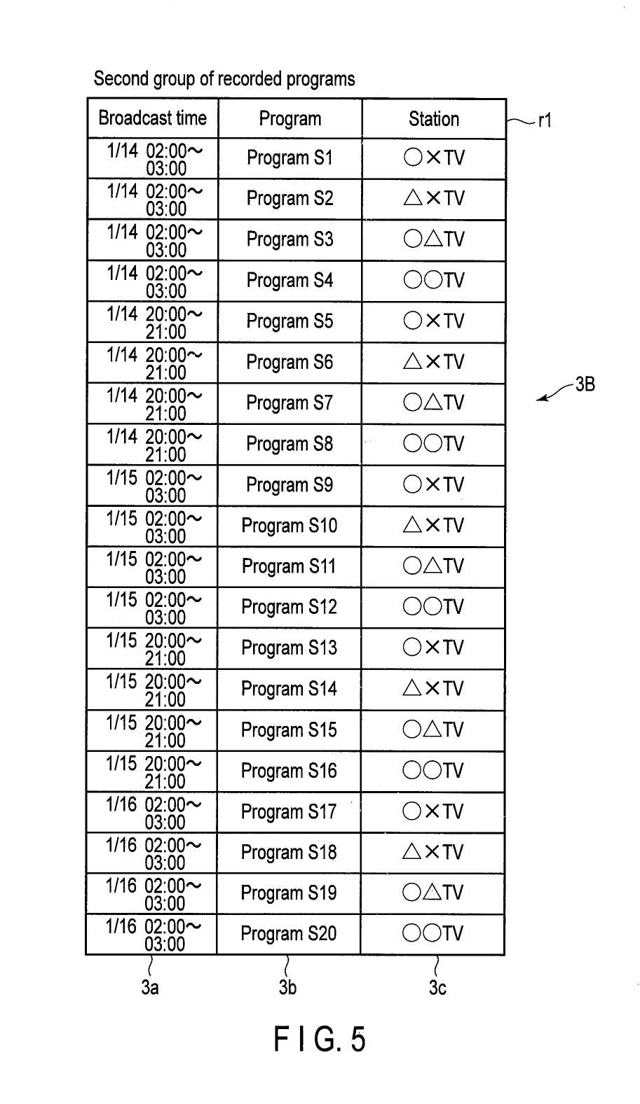

FIGS. 4 and 5 show a recorded-program list 3A and a recorded-program list 3B displaying the first and second groups of recorded programs made at 6:00 of February 17, respectively.

The recorded-program list 3A of FIG. 4 displays programs 1 to 100 broadcasted and recorded from 20:00 of January 16 to 6:00 of February 17. The recorded programs are included in the first group of recorded programs that are not yet determined whether they should be erased. In FIG. 4, the hatched recorded programs are those broadcasted in a time zone 2:00 to 3:00 or 20:00 to 21:00. Namely, the hatched recorded programs are erased later than those broadcasted in other time zones. The recorded-program list 3B of FIG. 5 displays recorded programs S1 to S20 included in recorded programs broadcasted before 20:00 of January 16 and broadcasted in the time zone of 2:00 to 3:00 or 20:00 to 21:00. The recorded programs S1 to S20 are included in the second group of recorded programs that were once determined by the program erasure 210 not to be erased.

As described above, since it is determined whether programs belonging to the first group should be erased beginning with a program whose recorded time/date, the recorded time/date (2:00 to 3:00 of January 16) of a newest program included in the second group is earlier than the recorded time/date (20:00 to 21:00 of January 16) of the oldest program included in the first group.

Assume here that the electronic device 1A continues time-shift recording to further record, in the storage device 151, programs 101 to 120 broadcasted from 6:00 of February 17 to 13:00 of February 17. In this case, in order to continue time-shift recording after 6:00 of February 17, the electronic device 1A determines whether recorded programs in the first group of recorded programs should be sequentially erased, beginning with a recorded program included in the first group and having an earliest time/date (i.e., program 1). As mentioned above, programs 1 to 4 were broadcasted in the time zone of 20:00 to 21:00 (calculated by the calculator 300), and will not be erased by the program erasure 210 and be shifted to the second group of recorded programs. If an erasure candidate program is not erased, the program erasure 210 erases, for example, programs S1 to S4 included in the second group to increase the residual data free area of the second group, in order to record a program broadcasted after 6:00 of February 17. Since the residual data free area has thus increased, the program recorder 220 can record a new program in the area from which program data has been erased by the program erasure 210. Programs 1 to 4 determined not to be erased by the program erasure 210 are excluded from the first group of recorded programs and included into the second group of recorded programs.

To enable the electronic device 1A to further continue time-shift recording, it is then determined whether programs 5 and 6 should be erased. Since the broadcast time zones of programs 5 and 6 are 21:00 to 22:00 and 21:00 to 23:00, respectively, the program erasure 210 does not change the class of these programs from the first group to the second group, and erases them. To continue time-shift recording, the program erasure 210 sequentially determines whether programs 7 et seq. should be erased.

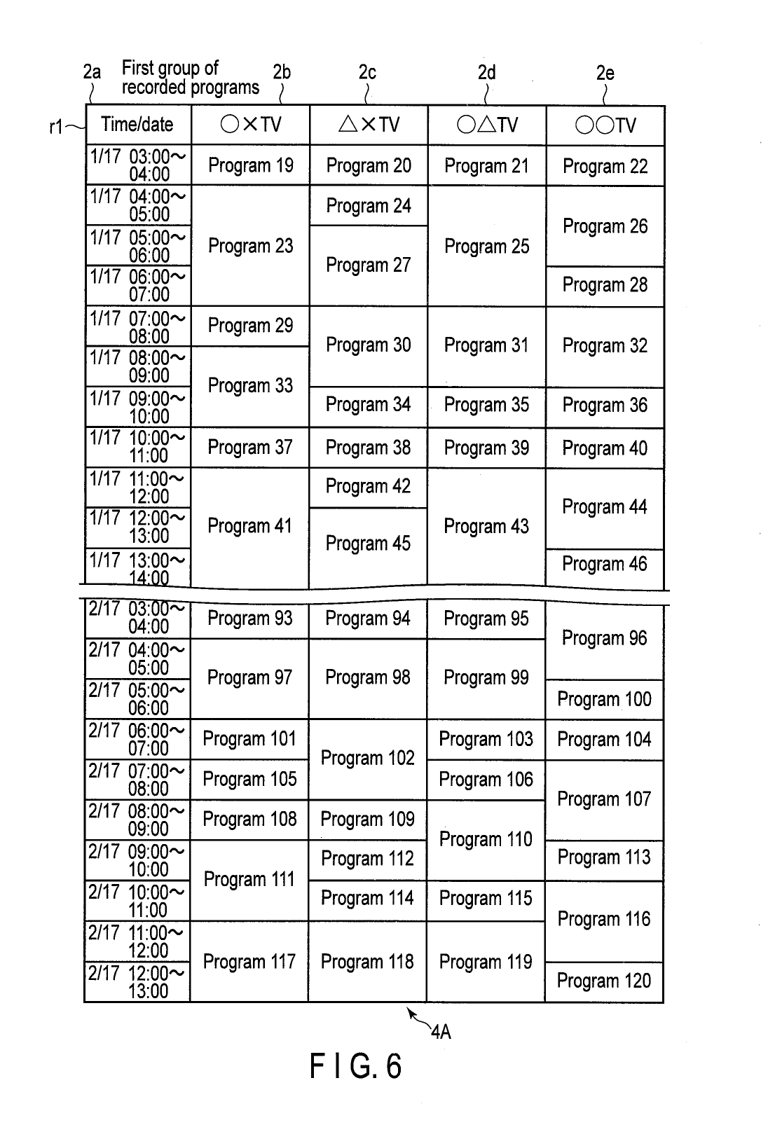

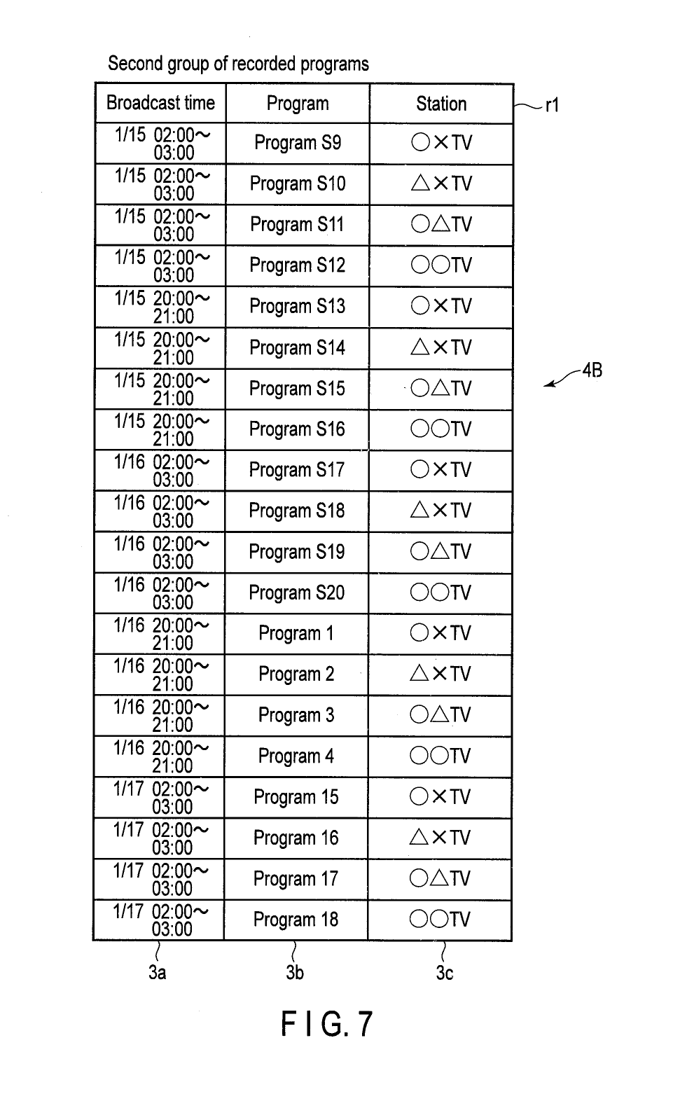

FIGS. 6 and 7 show a recorded-program list 4A and a recorded-program list 4B displaying the first and second groups of recorded programs made at 13:00 of February 17, respectively.

Unlike the recorded-program list 3A of FIG. 4, the recorded-program list 4A of FIG. 6 does not include programs 1 to 18 in the first group, and newly includes programs 101 to 120 in the first group. Namely, to further record programs 101 to 120 from 6:00 of February 17, the program erasure 210 has already determined that programs 1 to 18 included in the first group should be erased.

Unlike the recorded-program list 3B of FIG. 5, in the recorded-program list 4B of FIG. 7, programs S1 to S8 are already erased, and programs 1 to 4 and 15 to 18 are newly included in the second group. Namely, to newly record programs 101 to 120, the program erasure 210 has determined to erase programs S1 to S8 from the second group, and not to erase programs 1 to 4 and 15 to 18, with the result that programs 1 to 4 and 15 to 18 are not included in the first group but are included in the second group.

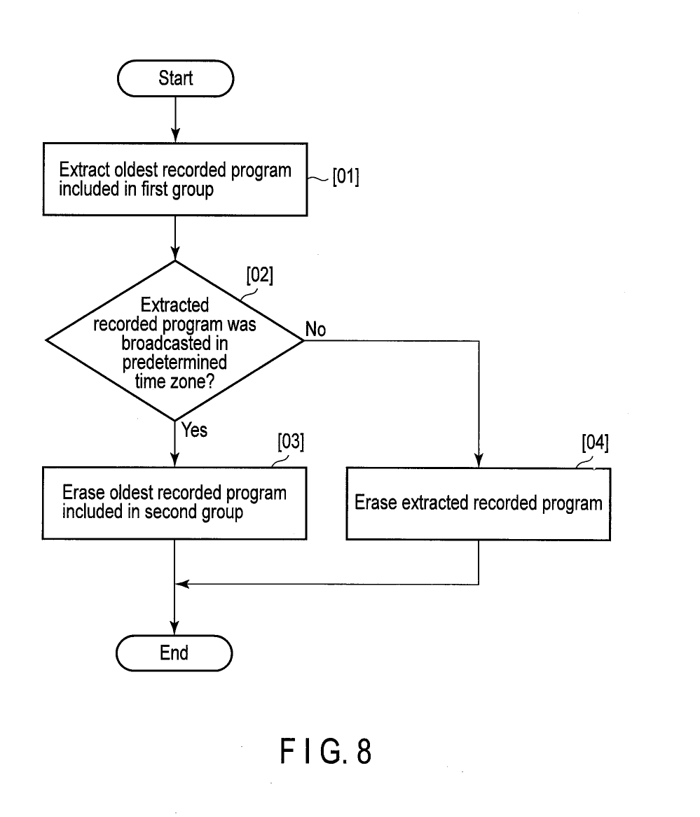

The above processing will be described again referring to the flowchart of FIG. 8. To continue time-shift recording, the program erasure 210 extracts an oldest recorded program included in the first group (step [01]). Subsequently, the program erasure 210 determines whether the extracted recorded program is a program broadcasted in a predetermined time zone ([02]). If the extracted recorded program is the program broadcasted in the predetermined time zone ([02]—Yes), the program erasure 210 erases an oldest recorded program included in the second group ([03]). In contrast, if the extracted recorded program is not the program broadcasted in the predetermined time zone ([02]—No), the program erasure 210 erases the extracted recorded program ([04]).

As described above, in the electronic device 1A of the first embodiment, a time zone to be referred to for selecting a recorded program to be stored preferentially (or a recorded program whose erasure should be postponed) is calculated by the calculator 300. A recorded program broadcasted in the time zone determined by the calculator 300 will be erased later than recorded programs broadcasted in other time zones, even though it is not actually replayed. Accordingly, the possibility of erasing a recorded program that is not yet viewed but is broadcasted in a time zone in which the user often views a program becomes weak. Further, when the user views a particular program broadcasted in a certain time zone every day (or every week), they may wish to view another program broadcasted in the same time zone as the above-mentioned program. However, it is strongly possible that they fail to view another program. In the electronic device 1A of the first embodiment, other programs broadcasted in the same time zone can be prevented from being erased non-viewed. In other words, in the electronic device 1A of the first embodiment, programs that are not yet replayed but may well be replayed by the user will be erased later than programs whose possibility of replay is low.

### Second Embodiment

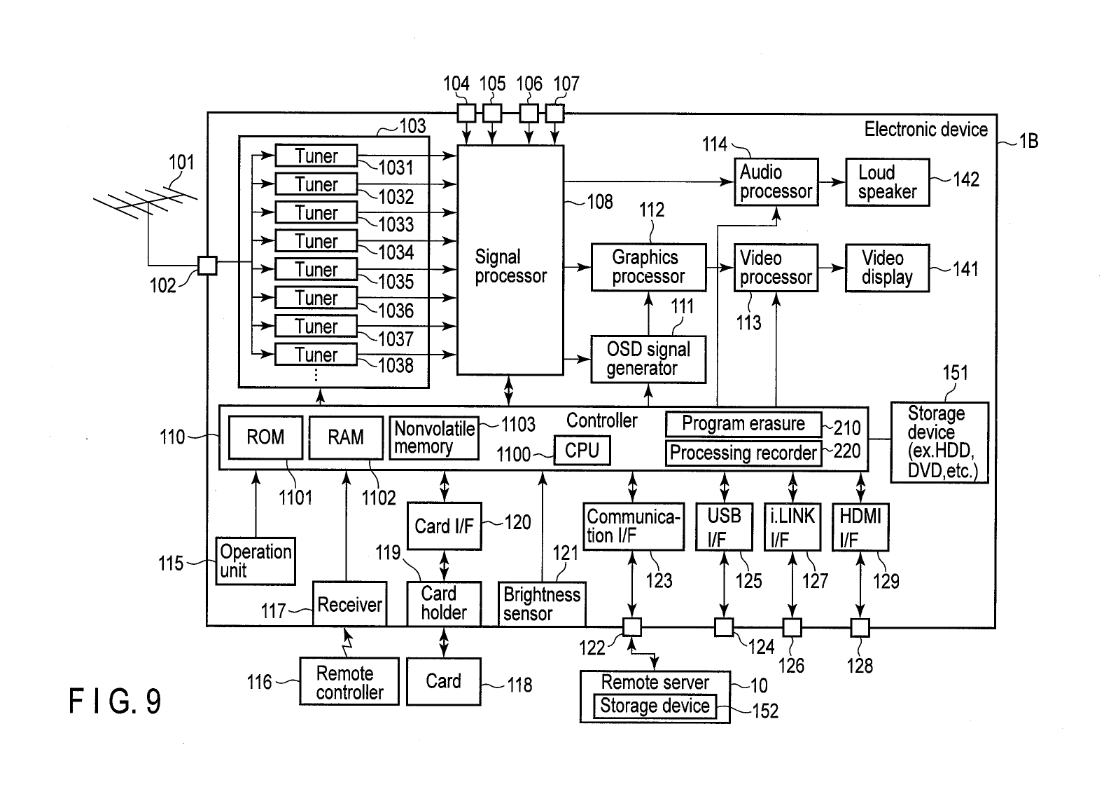

FIG. 9 is a block diagram showing a configuration example of an electronic device 1B according to a second embodiment. The electronic device 1B of the second embodiment is similar to the electronic device 1A of the first embodiment except that in the former, the controller 110 does not comprise the calculator 300. In the electronic device 1B, the user registers, in a nonvolatile memory 1103 using, for example, a remote controller, the time zone of a recorded program that the user wishes to store preferentially (or a recorded program that the user wishes to postpone its erasure). When determining whether a recorded program should be erased, the program erasure 210 refers not to a time zone calculated by the calculator 300, but to a time zone registered by the user in the nonvolatile memory 1103 using, for example, the remote controller.

The electronic device 1B of the second embodiment also has an advantage similar to that of the electronic device 1A of the first embodiment. Namely, also in the electronic device 1B of the second embodiment, erasure of a program whose replay by the user is strongly possible is postponed, compared to a program whose replay possibility is weak.

The present invention is not limited to the above-described embodiments, but may be modified in various ways without departing from the scope. Various inventions can be realized by appropriately combining the structural elements disclosed in the embodiments. For instance, some of the disclosed structural elements may be deleted. Some structural elements of different embodiments may be combined appropriately.

For instance, the program erasure 210 may regularly perform erasure of recorded programs on, for example, a particular date or time, instead of when the data free areas of the first and second groups of recorded programs have been reduced.

Further, although in each of the above-described embodiments, upper limits are set for the data capacities of the first and second groups of recorded programs, they may be variable.

If the upper limits set for the data capacities of the first and second groups are variable, the program erasure 210 does not always have to erase an oldest recorded program included in the second group, even if a recorded program to be determined whether to be erased was broadcasted in a predetermined time zone. For instance, if only 80% of the recording capacity of the storage device 151 is used for recorded programs, the program erasure 210 may raise the upper limit for the data capacity of the second group, and determine not to erase the oldest recorded program from the second group. Alternatively, the program erasure 210 may raise the upper limit for the data capacity of the second group and reduce that for the data capacity of the first group, thereby determining not to erase the oldest recorded program from the second group. In other words, the program erasure 210 does not erase the oldest recorded program from the second group even when an erasure candidate program is determined not to be erased from the first group.

When the program erasure 210 does not erase an erasure candidate program included in the first group, and does not erase an oldest recorded program which is included in the second group and whose time/date is earliest, the recorded programs broadcasted in a predetermined time zone are stored for a longer period of time (or their erasure is postponed for a longer period of time). For instance, the program erasure 210 may raise the upper limit for the data capacity of the second group so that a program broadcasted in a predetermined time zone can be stored for an arbitrary period of time (e.g., 1.5 or 2 times or more the storage period of a program broadcasted in a time zone other than the predetermined time zone). Further, when reducing the upper limit for the data capacity of the first group, the program erasure 210 may erase, for example, a second oldest recorded program included in the first group.

Furthermore, the program erasure 210 may erase a program recorded in a predetermined time zone, later than a program recorded earliest in the time zone other than the predetermined time zone, and earlier than a program broadcasted in the time zone other than the predetermined time zone and recorded after. In this structure, programs broadcasted in the predetermined time zone are necessarily erased at a certain time point, which makes it unnecessary to increase the upper limit for the data capacity of the second group.

Yet further, the calculator 300 may calculate a time zone to be referred to for determining whether to erase data, on a day of a week basis. In this case, the calculator calculates the number (frequency) of replays of each recorded program in each time zone on each day of the week.

Also, when calculating a time zone to be referred to for determining whether erasure should be performed, the calculator 300 may incorporate, in a replay count, viewing a program on-air.

In addition, when calculating a time zone to be referred to for determining whether a program should be erased, the calculator 300 may search, for example, an SNS site on the Internet for comments on the recorded program, thereby calculating the number of comments associated with the recorded program, instead of calculating the number of replays of the recorded program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a program erasure configured to erase a recorded program included in a plurality of recorded programs and recorded earlier than other recorded programs; and
a program recorder configured to record, in an area from which the recorded program is erased by the program erasure, new programs broadcasted in a predetermined time zone and a time zone other than the predetermined time zone,
wherein the program erasure erases a program recorded in the predetermined time zone, later than a program recorded earliest in the time zone other than the predetermined time zone, and earlier than a program which was broadcasted in the time zone other than the predetermined time zone and was recorded after the program recorded earliest.

2. The electronic device of claim 1, wherein the predetermined time zone is where a ratio of replays of recorded programs is higher than in the time zone other than the predetermined time zone.

3. The electronic device of claim 1, wherein the predetermined time zone is where a frequency of replays of a recorded program is higher than in the time zone other than the predetermined time zone.

4. The electronic device of claim 2, wherein
the predetermined time zone is set for each day of a week; and
the program erasure erases a program recorded in the predetermined time zone on a predetermined day of the week, later than a program recorded earliest in the time zone other than the predetermined time zone on the predetermined day of the week, and earlier than a program which was broadcasted in the time zone other than the predetermined time zone on the predetermined day of the week and was recorded after the program recorded earliest.

5. The electronic device of claim 1, further comprising a storage device in which the program recorder records programs.

6. The electronic device of claim 1, further comprising a communication unit,
wherein the communication unit communicates with a data server provided with a recorder; and
the program recorder records programs in the recorder.

7. The electronic device of claim 1, further comprising a tuner which receives broadcast signals.

8. The electronic device of claim 1, further comprising a display which displays video images of programs.

9. A recorded program processing method comprising:
erasing a recorded program included in a plurality of recorded programs and recorded earlier than other recorded programs;
recording, in an area from which the recorded program is erased by the program erasure, new programs broadcasted in a predetermined time zone and a time zone other than the predetermined time zone; and
erasing a program recorded in the predetermined time zone, later than a program recorded earliest in the time zone other than the predetermined time zone, and earlier than a program which was broadcasted in the time zone other than the predetermined time zone and was recorded after the program recorded earliest.
